(19) United States
(12) Patent Application Publication
(10) Pub. No.: US 2012/0234744 A1
(43) Pub. Date: Sep. 20, 2012

(54) FILTRATION SYSTEM

(75) Inventor: GARY LAWSON, Suffolk, VA (US)

(73) Assignee: General Foam Plastics Corporation, Norfolk, VA (US)

(21) Appl. No.: 13/226,431

(22) Filed: Sep. 6, 2011

Related U.S. Application Data
(60) Provisional application No. 61/379,765, filed on Sep. 3, 2010.

(51) Int. Cl. B01D 36/04

(52) U.S. Cl. 210/295

(57) ABSTRACT

A filtration system for a container, such as a fish pond, can include mechanical and biological filtering in a self-contained apparatus for attachment to a submersible centrifugal pump. The filtration system includes a base assembly, to which at least one mechanical filter can be attached, and which can accommodate biological media such as Bio-Balls. The mechanical filters can be a foam material, cylindrically shaped and detachable from a lid portion of the base for easy access without disturbing the biological media. A fountain sprayer mechanism, controlled by a two-way control valve, can optionally be used to provide a decorative effect. The filtration system and pump are easily separated when the pump requires maintenance without disturbing the natural ecosystem. By connecting two or more base assemblies in series, via a base coupling mechanism, the user can achieve increased filtering without the necessity to purchase and install additional pumps.

### CROSS REFERENCE TO RELATED APPLICATION

This application claims benefit under 35 USC §119(e) of U.S. Provisional Patent Application Ser. No. 61/379,765 filed 3 Sep. 2010, the entire contents and substance of which is hereby incorporated by reference.

### FIELD OF THE INVENTION

Embodiments of the present invention relate to filter systems and, more particularly, to a filter system for use with fish ponds and the like.

### BACKGROUND

Fish ponds are commonly used as ornamental landscaping features in many residential and commercial gardens. Such ponds are designed to look as natural as possible, and pond owners use various methods, including filtration systems, to maintain the water quality and achieve conditions in the pond that are close to the natural environment. Adequate filtration of the pond water is essential to maintaining an attractive and functioning fish pond.

Fish ponds accumulate and generate a variety of contaminants and waste products that must be removed and treated to maintain the attractive appearance of the fish pond and the health of the fish or pond plants living therein. The exposed water surface tends to retain air-blown dust, dirt, and leaves and other plant matter that falls in. The fish themselves produce excrement that is a solid waste material and a source of unwanted biological activity. The temperate closed water ecosystem that is essential for the fish is also an excellent environment for the growth of algae and other undesirable living organisms. Fish food that remains uneaten by the fish also can contaminate the pond and nourish undesirable living organisms. The closed system of a fish pond also favors chemical processes such as ammonia production that, if left unchecked, can rapidly degrade the appearance of the fish pond and its ability to support healthy fish or pond plants.

Filtering methods are known and well understood; such methods fall into one of three main categories: mechanical filtering, biological filtering, or chemical filtering. Conventional filters may include one or more of these methods, with mechanical and biological filtering being the most commonly used methods alone or in combination with each other. Such systems are referred to herein as bio-filtering systems, which is to be understood to include aspects of both mechanical and biological filtering.

Mechanical filtering is perhaps the simplest method, based on the principle that larger sized particles are unable to pass through certain barriers in the mechanical filter. The most common filter materials are foams and sponges. Biological filtering operates on the principle that providing an ample surface will encourage the growth of beneficial bacteria that will help breakdown toxic waste into less harmful chemicals. Some of the most popular and commonly used biological media are Bio-Balls.

As an example of a conventional system, FIG. 1 depicts a bio-filter system that includes both mechanical and biological filtering capability. This type of conventional system is manufactured by Beckett Corporation, Irving, Tex., and sold as a Biological Pond Filter (Model No. BF350A20, as an example). Such a system can provide relief from the unwanted growth of algae and other undesirable living organisms, which can be useful for providing a healthy pond environment. But, such systems are inherently limited in several respects.

First, in the type of system depicted in FIG. 1, the pump is inside the “box” that contains the filters themselves. This is undesirable for a number of reasons, a main reason being that accessing the pump (for cleaning, maintaining, and/or replacement) necessarily requires opening the box, which most likely will disturb the natural bio-system colony that is cultivated by the biological media. This is particularly important if, for example, the pump were to develop a leak of oil or other unwanted fluids, which can destroy the natural ecosystem.

Similarly, because the mechanical filter of the conventional system of FIG. 1 is located within the lid portion of the box, gaining access to the filter also requires opening of the box, which again can disturb the natural environment that the bio-filter is designed to promote in the first instance. Further, by locating the pump inside the box, there is less real estate available for the biological media to perform their desired functions.

Second, the amount of surface area available for filtration is limited by the size of the box of the conventional system depicted in FIG. 1. Thus, for example, the size of the lid portion of the box in FIG. 1 dictates the size of the mechanical filter, which, in turn, limits the filtration potential. A smaller filter size not only minimizes the filtration capability, but also reduces the time necessary between the filter cleaning and/or replacement.

Third, conventional systems often require specialized equipment such as hoses, seals, and clamping mechanisms to assemble the component parts, which requires additional space in the pond, and requires additional steps to assemble and disassemble the parts for cleaning, maintenance, and/or replacement. The use of such equipment also poses the potential for leaks that can destroy the pond environment.

Finally, the filtering capacity of a conventional type of system, such as that depicted in FIG. 1, is inherently limited because only one filer box (i.e., one filter) can be used at a given time with the pump. In addition, to increase the filtering capacity requires the user to purchase and install an additional box along with an additional pump.

### SUMMARY

Briefly described, embodiments of the present invention relate to a filtration system for use with fish ponds and the like.

Embodiments of the present invention relate to a bio-filter filtration system. The bio-filter filtration system includes both mechanical filtering and biological filtering to maintain the water quality and achieve conditions in a container, such as a pond, that are close to the natural environment. In particular, the filtration system provides a conveniently-configured apparatus that can be located inside the pond, and that offers relative ease of assembly and disassembly for cleaning, maintenance, and/or refurbishment.

In an exemplary embodiment, the bio-filter filtration system comprises a base assembly, at least one mechanical filter, at least one form of biological media, and a base connection for attachment of the base to a pump.

In this embodiment, the base assembly can comprise a bottom portion and a detachable lid portion. The bottom portion can further comprise at least one side wall extending upwardly from a perimeter of the bottom portion to form a cavity that can accommodate biological media, such as Bio-balls, to provide biological filtering. In an exemplary embodiment, the detachable lid portion can accept up to five mechanical filters to provide mechanical filtering. The detachable lid is designed to enable convenient access to the biological media for ease of cleaning, maintenance, and replacement. The mechanical filters can comprise a strainer component and a filter component that are detachably coupled to the lid portion for easy access, and without disturbing the biological media. The strainer component can attach to an upper surface of the lid portion, and the strainer is sized and shaped to receive the filter component. The filter component can comprise a foam material with a cylindrical aperture through its core sized to accept the strainer component. The bottom portion of the base can further comprise a base connection to operably couple the base to the pump, which can, for example, be a submersible centrifugal pump. Because the pump can be located outside of the base, there is more room inside the base for the biological media, and the pump can be readily separated from the base for cleaning or maintenance without disturbing the natural ecosystem.

In the exemplary embodiment, the filtration system can be attached to a submersible, centrifugal pump such that the assembly can operate while submerged in the pond without the need to decorate or camouflage the system to preserve the natural appearance of the pond. The pump can attach directly to the base assembly by inserting a base connection into a cooperatively-shaped aperture located on the bottom portion of the base. This connection can be made by way of a press fit, eliminating, or reducing, the need for tools or equipment, such as hoses or seals. Because the pump is designed to operate while submerged, there is no need for priming or bleeding of the pump, and the flow of water can begin upon turning on the pump, e.g., immediately. The filtration system and pump are easily separated when the pump requires maintenance or replacement without disturbing the natural ecosystem.

In another exemplary embodiment, the filtration system can further include a fountain sprayer mechanism, controlled by a two-way control valve, which can optionally be used to provide a decorative effect and to return filtered water back into the pond. The two-way valve has an inlet aperture, which can be attached directly to a fountain connection of the pump, and an outlet aperture that can be connected to the fountain sprayer mechanism. A second outlet aperture of the control valve can be used as a return mechanism for directing water back into the pond instead of (or in addition to) using the fountain sprayer mechanism. The two-way valve also has a control knob for controlling the supply of water to the fountain.

In an alternate embodiment, two or more base assemblies can be connected in series, for example, such that the user can achieve increased filtering or longer intervals between maintenance and cleaning without the necessity of purchasing and installing additional pumps. Although the present disclosure and figures depict two assemblies connected in series, it is to be understood that up to five base assemblies can be connected and used with a single pump.

Further features of embodiments of the present invention, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

FIG. 1 illustrates a representative conventional filtration system.

FIG. 2 illustrates a front perspective view of a bio-filter filtration system, in accordance with an exemplary embodiment of the present invention.

FIG. 3A illustrates a front perspective partial cut-away view of the bio-filter filtration system of FIG. 2, in accordance with an exemplary embodiment of the present invention.

FIG. 3B illustrates another front perspective partial cut-away view of the bio-filter filtration system of FIGS. 2 and 3A, in accordance with an exemplary embodiment of the present invention.

FIG. 4 illustrates a rear perspective view of the bio-filter filtration system of FIGS. 2-3B, in accordance with an exemplary embodiment of the present invention.

FIG. 5 illustrates a front perspective view of the bio-filter filtration system of FIGS. 2-4 with two base units coupled together, in accordance with an exemplary embodiment of the present invention.

### DETAILED DESCRIPTION

To facilitate an understanding of the principles and features of embodiments of the invention, they are explained hereinafter with reference to their implementation in an illustrative embodiment. In particular, embodiments of the present invention are described in the context of filtration systems. More particularly, embodiments of the present invention are described in the context of a filtration system for use with ponds and the like. For example, embodiments of the present invention relate to a system that combines the benefits of mechanical and biological filtering in a self-contained apparatus that can operate while submerged in the water to increase efficiency and improve the maintainability of the system.

Embodiments of the present invention, however, are not limited to its use in a fish pond. Rather, embodiments of the invention can be used in any setting wherever a body of water is used for decorative or fish-breeding purposes or growing pond plants, and it is desired or needed to provide filtering to eliminate waste and unwanted organisms and to promote the flow of productive bacteria. Thus, the filtration system described hereinafter for use as a fish pond filter can also find utility as a filter for a container or other artificial garden or fountain that can benefit from the advantages of an improved filter with both mechanical and biological filtering capabilities.

Additionally, the materials and components described hereinafter as making up the various elements of the protection system are intended to be illustrative and not restrictive. Many suitable materials and components that would perform the same or a similar function as the materials and components described herein are intended to be embraced within the scope of the invention. Such other materials and components not described herein can include, but are not limited to, materials and/or components that are developed after the time of the development of embodiments of the present invention, for example.

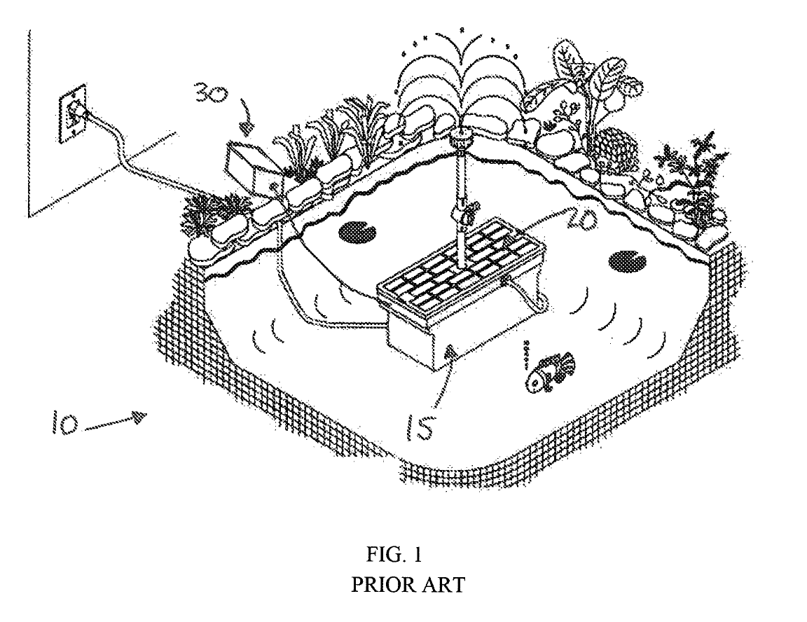

Referring now in detail to the figures, wherein like reference numerals represent like parts throughout the several views, FIG. 1 illustrates a conventional filtration system 10. Such a system is generally in the shape of a rectangular box 15—including mechanical filtering means 20, which in this type of system is limited to one planar section of the box 15, and biological filtering means (not shown in FIG. 1), which is also located inside the rectangular box 15. Depending on the size of the box 15, the filter system 10 can be located inside the fish pond or other body of water, and a pump 30 can be distal to the box 15, or located within the box 15.

When the filter system 10 is in use, water is drawn through the box 15 via the pump 30, which, in turn, is filtered through the mechanical filter 20 and then through the biological filter located inside the box 15, whereupon the filtered water is returned to the pond. Operating the filter system 10 continuously (or at designated/selected intervals) enables the pond owner to improve the quality of the water in the pond.

Conventionally, the available filtration potential is dictated by the size of the box 15, which limits the size of the mechanical filter 20, and which likewise limits the amount of biological filtering available. Therefore, the only way to increase the amount of filtration in a conventional system is to purchase and install additional filter system units 10 at great expense to the pond owner (since each unit 10 also nominally requires the purchase of a separate pump 30).

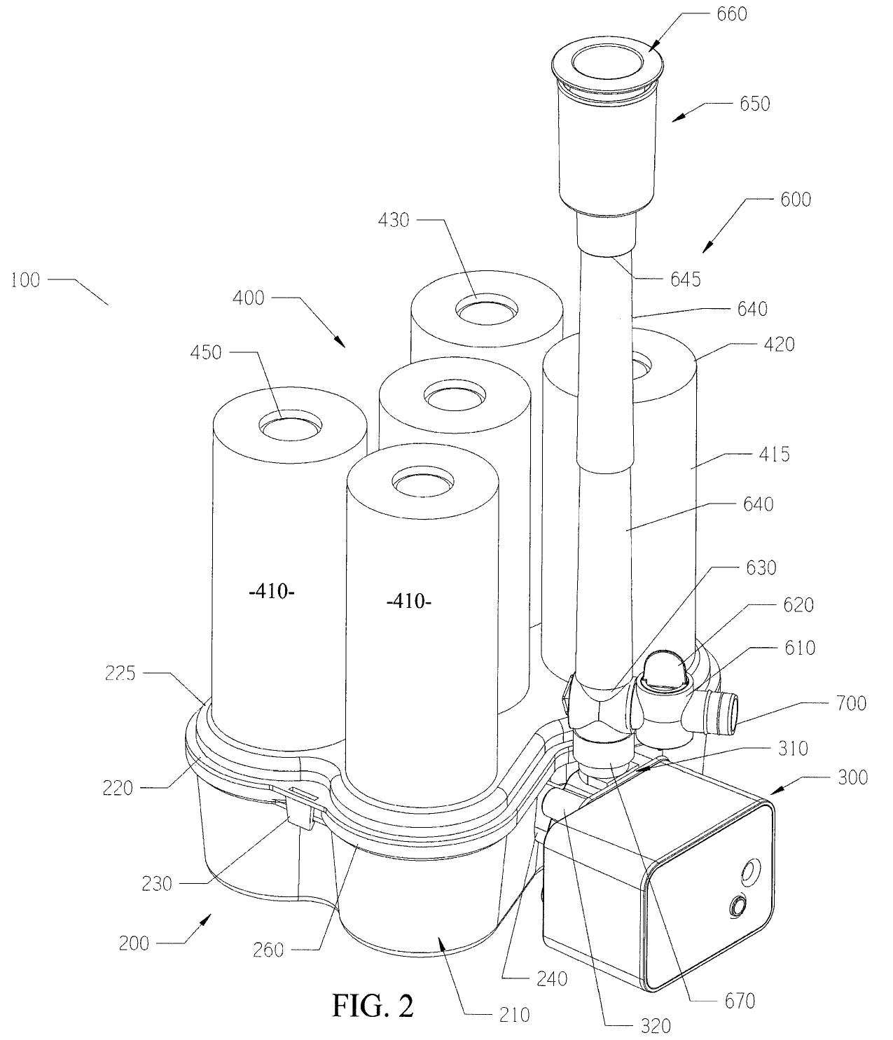

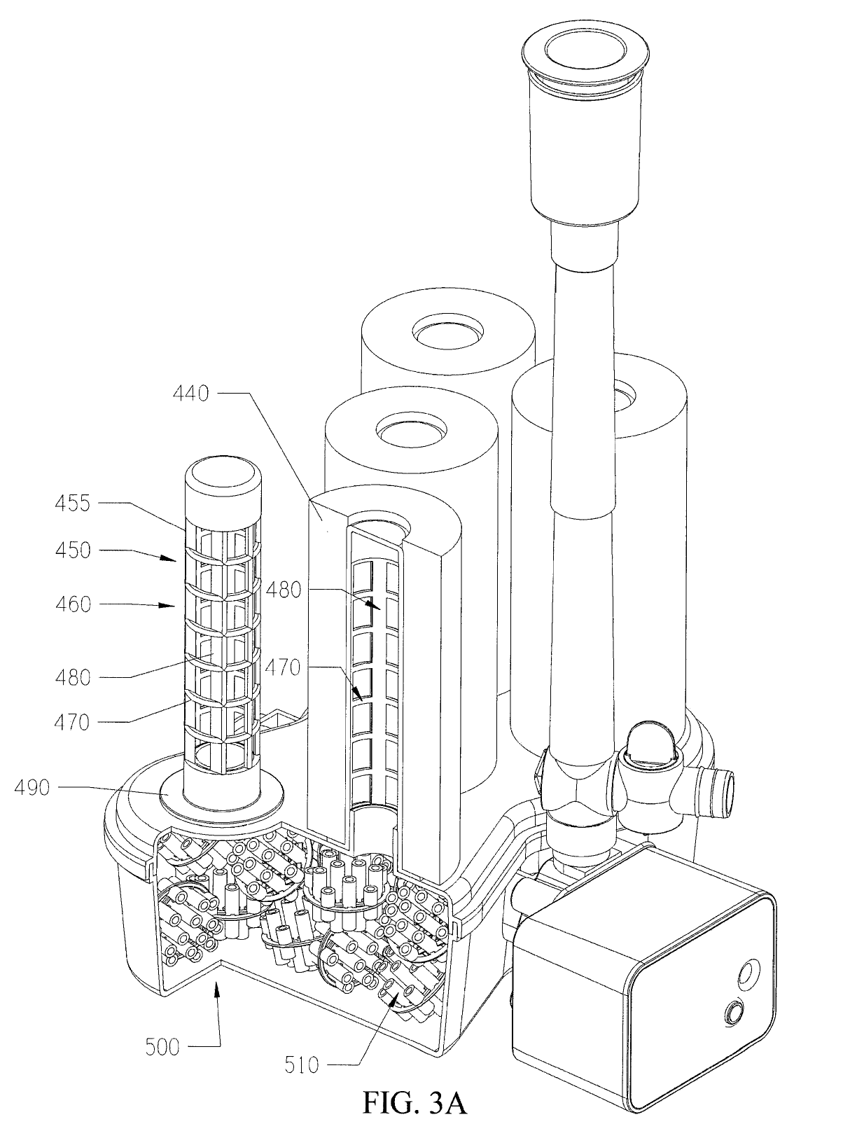

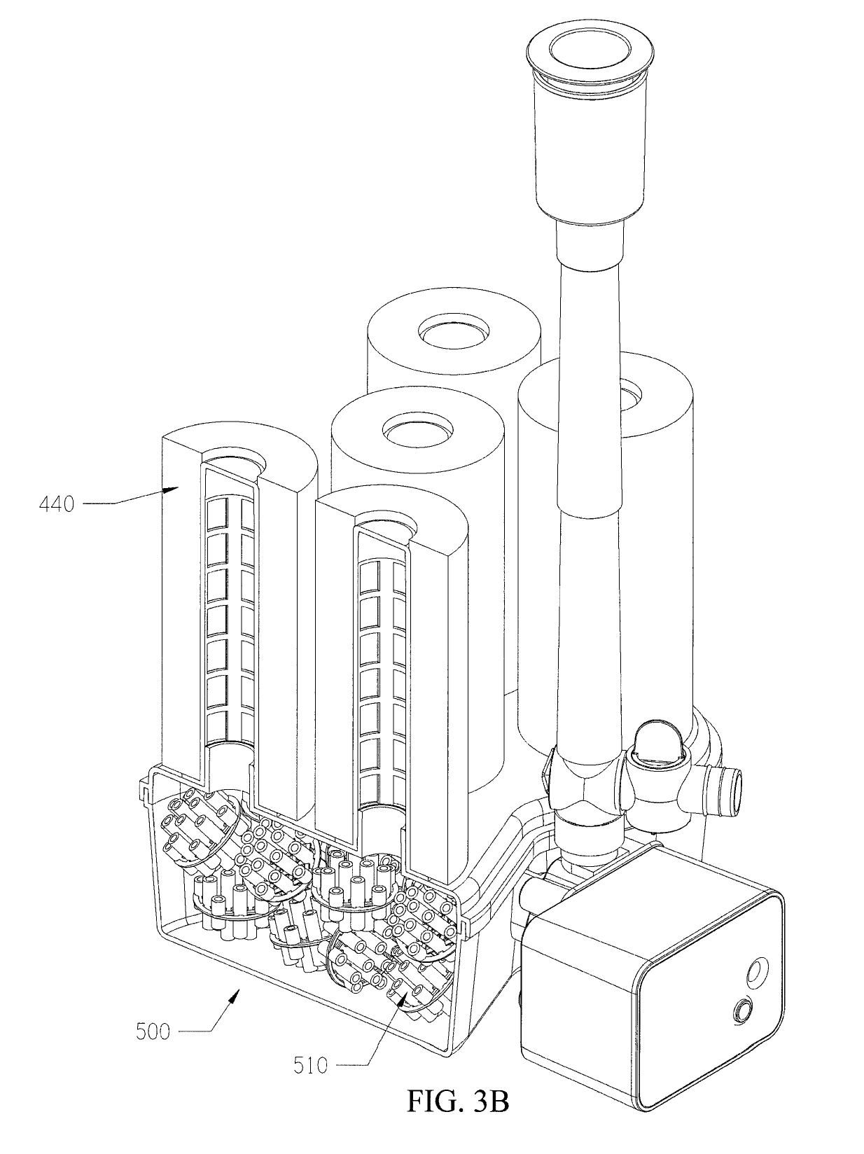

FIGS. 2-4 illustrate various views of a bio-filter filtration system 100, in accordance with an exemplary embodiment of the present invention. In an exemplary embodiment, the filtration system 100 includes a base 200, which can incorporate both mechanical filtering 400 and biological filtering 500, and which can be operably coupled to a pump 300 through a base connection (pump coupling mechanism) 310, to provide at least a dual-filtration system (mechanical and biological filtering). The mechanical filtering 400 is provided by a series of mechanical filters 410 (in FIGS. 2-4, five such filters shown), whereas the biological filtering 500 is provided by the inclusion of biological media 510 located inside the base 200 (depicted in FIGS. 3A and 3B as Bio-Balls). The entire assembly, including the base assembly 200, and its component parts, and the pump 300, is designed to operate while submerged in the pond; thus eliminating the need to decorate or camouflage the system during operation. The filtration system 100 can further include a fountain sprayer mechanism 600 that can direct the return flow of water back into the pond to provide a decorative effect.

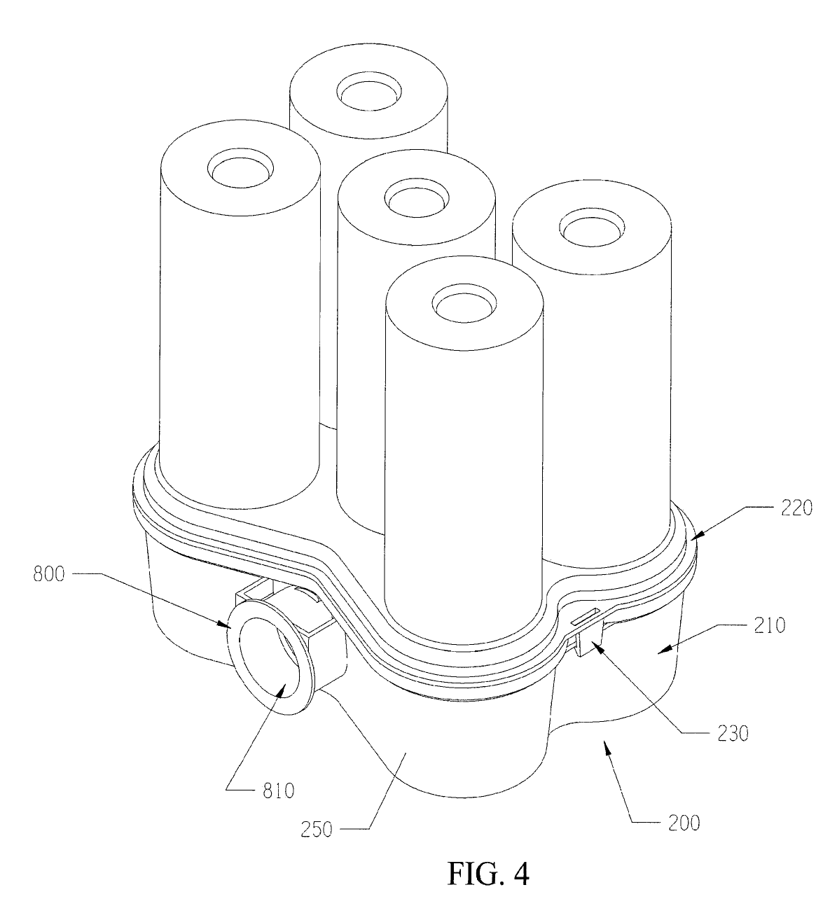

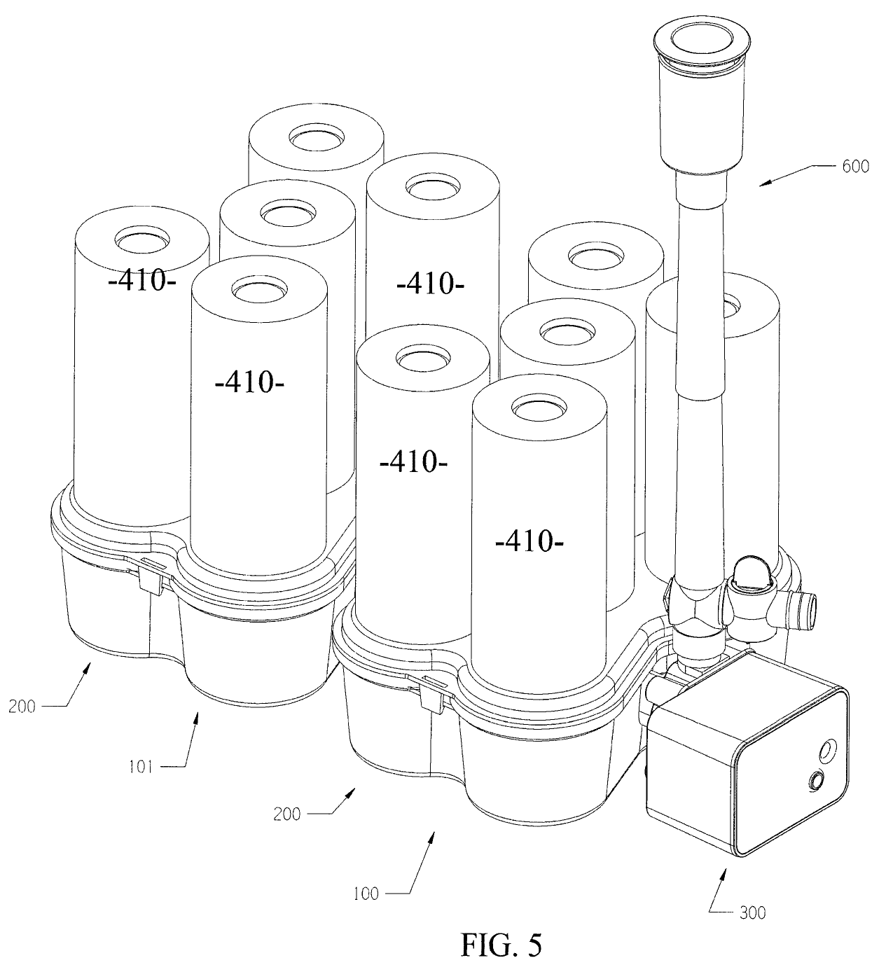

Also, FIG. 5 depicts an alternate embodiment of the present invention in which a second bio-filter filtration system 101 (depicted in FIG. 5 without a fountain sprayer mechanism 600) is coupled with a first bio-filter filtration system 100 to provide enhanced filtration for larger ponds that require additional filtration or longer intervals between maintenance and cleaning. The coupling is accomplished by a base coupling mechanism 800 located on a rear face 250 of the bottom portion 210 of the base 200 as shown in FIG. 4. The base coupling mechanism 800 includes an aperture 810 into which a coupling device (not shown) can be inserted and then attached to a mating aperture (also not shown) located on the bottom portion 210 of the base 200 of the second bio-filter filtration system 101 as shown in FIG. 5.

The individual components of each embodiment of the bio-filter filtration system 100, along with their advantages and design features, will now be described in more detail with reference to the aforementioned FIGS. 2-5.

### Base

As shown in FIG. 2, the bottom portion 210 includes a bottom and at least one side wall extending upwardly from a perimeter of the bottom of the bottom portion 210. In this embodiment, the base 200 can include a bottom portion 210 and a detachable lid portion 220. The bottom portion 210 is shaped in the form of a thin-walled cavity that affords a convenient location for placement of the biological media 510 that are part of the biological filtering system 500. In a preferred embodiment, the biological media 510 can be Bio-Balls (described hereinafter), which, due to their spherical shape, provide enhanced surface area to accomplish the biological filtration.

In this embodiment, the lid portion 220 of the base 200 is detachable from the bottom portion 210 of the base 200. This provides a convenient way to access the biological media 510 for cleaning, maintenance, and/or or replacement of the biological media 510 and/or the interior of the base 200. Yet the lid portion 220 (when secured in place) can enclose the biological media 510 within the base 200 to ensure proper performance during operation and use of the filtration system 100.

FIG. 2 depicts the base 200 in an assembled configuration, that is, the lid portion 220 is attached to the bottom portion 210. In this embodiment, the lid portion 220 is attached to the bottom portion 210 by way of a snap on-off latch 230 that is located on a left face of the base 200 (there is a similar latch located on the right side of the base 200, which is not shown in the figure). In FIG. 2, the snap on-off latch 230 is in an “on” position. In FIGS. 3A and 3B, a cut-away view of the base 200 depicts how the lid portion 220 is coupled to the bottom portion 210 in this embodiment. There are, of course, other ways to accomplish this feature (e.g., a press fit between the lid portion 220 and the bottom portion 210), so long as the seal between the lid portion 220 and the bottom portion 210 remains relatively water-tight.

In this embodiment, the side wall of the bottom portion 210 of the base 200 can further include a base aperture 240 that receives a base connection 320 of the pump 300 (described below) to operably couple the pump 300 to the base assembly 200 as depicted in FIG. 2. The base connection 320 can have, for example, a circular cross-section slightly smaller than an inner diameter of the base aperture 240 such that the pump 300 can be coupled to the base 200 by a press fit and without the need for any tools, hoses, or seals. This also allows the pump 300 to be easily separated from the base assembly 200 for ease of cleaning, maintenance, and/or replacement of component parts.

### Mechanical Filtering

In an exemplary embodiment, the mechanical filtering 400 is accomplished by a series of mechanical filters 410 that are operably coupled to an upper portion 225 of the lid portion 220 of the base 200. In the exemplary embodiments depicted in FIGS. 2-5, for example, there are five such mechanical filters 410 attached to the lid portion 220. In these embodiments, the shape of an outer periphery (planform) 260 of the base 200 is dictated by the cross-section 420 of the cylindrical shape of the mechanical filters 410 to accommodate the placement of five such filters 410 distributed across the planform 260 of the base 200. It is to be understood, however, that other embodiments are possible, and the figures described herein are not to be considered limiting as to the scope of the present invention. The inventors have found in practice, however, that five mechanical filters 410 provide an optimal performance in most settings. If additional filtering is desired or required, an alternate embodiment of the present invention (described hereinafter) can enable coupling of two or more bio-filter filtration systems 100 that together can operate from a single pump 300 as depicted in FIG. 5.

The mechanical filters 410 can include a strainer component 450 and a filter component 415 that are operably coupled together. In the exemplary embodiment depicted in FIGS. 2-5, for example, the filter component 415 is preferably a foam material, which is selected from any number of well understood foam materials having sufficient porosity and density to provide filtering of small-medium particles without impeding the flow of water through the filtration system 100. The filter component 415 is cylindrically sized and shaped with an aperture 430 through its core to receive the strainer component 450 (described hereinafter) as depicted in FIGS. 3A and 3B.

FIGS. 3A and 3B depict a cut-away view of a representative mechanical filter 410 to reveal how an inner wall 440 of the cylindrical aperture 430 through its core can be fitted over an outer wall 455 of the strainer component 450.

In this embodiment, the strainer component 450 can be attached to the base 200 by a base attachment mechanism 490 or another suitable attachment method that allows the strainer 450 to be readily detached from (and, likewise, reattached to) the upper portion 225 of the lid portion 220 of the base 200 for ease of cleaning, maintenance, and/or replacement. For example, the strainer 450 could be attached to the base 200 by way of screw threads. As depicted in FIG. 3A, and the cut-away view of FIG. 3B, the base attachment mechanism 490 can be a flange having an aperture (not shown) that can receive a corresponding raised hub (also not shown) located on the lid portion 220 of the base 200. In the embodiment of FIG. 3A, there are five mechanical filters 410, thus there would be an equal number of strainer components 450, each having a base attachment 490, and a corresponding hub (not shown) to receive the strainer component 450.

The strainer 450 is cylindrically sized and shaped to receive the filter component 415 (described hereinabove). The main body portion 460 of the strainer 450 can be constructed with an open webbing (typically comprised of orthogonal lateral 470 and transverse 480 members that are interconnected as shown in FIGS. 3A and 3B). They provide sufficient structural stiffness and stability without impeding the flow of water through the mechanical filter 410. It is to be understood that the size and shape of the webbing 470, 480 can be selected to provide coarse filtering (i.e., to prevent leaves, rocks, and other large debris from entering the filter if, for example, the filtration system 100 were to be operated without the foam covering of the filters 415 in place); however, the primary mechanical filtering 400 is provided by the foam filters 415 themselves.

In this embodiment, the mechanical filters 410 of this embodiment offer several benefits over conventional systems. First, the filter component 415 can be easily assembled onto and removed from the body portion 460 of the strainer component 450 for ease of installation and removal (for cleaning, maintenance, and/or replacement). In particular, the ability to slide the filter component 415 on and off the strainer component 450 enables the user to access those filters directly (e.g., by reaching into the pond) without having to remove the entire filtration system 100 from the pond, or without having to open the base 200 to reach inside and change the filter, as would be required if one used the box 15 of a conventional filtration system 10, such as that shown in FIG. 1.

Second, the surface area of each cylindrically-shaped filter 415 is significantly greater than the surface area provided by conventional filters, such as that shown in FIG. 1, which is limited to the planar area corresponding to the cross-section of the box 15. Third, by placing five such mechanical filters 410 on the base 200, the mechanical filtering 400 provided by this embodiment of the invention is vastly improved over that provided by conventional filters for the same reasons just described.

It should also be noted that the assembled configuration of the aforementioned embodiment (as depicted in FIGS. 2 and 3A, and comprising the base assembly 200, mechanical filtering 400, biological filtering 500, and fountain sprayer 600. Pump 300) also offers an improvement over the conventional single-filtering system that could be used with the pump 300 of the present invention. So, for example, a strainer component 450 can be inserted into the base connection 320 of the pump 300, and a filter component 410 can be pressed onto the strainer component 450, as described hereinabove, which would provide a single mechanical filtration assembly. This would provide a single-filter mechanical filtration system. Such a system, of course, would be limited in its performance because it would not have the benefit of the four other mechanical filters 410 or the biological media 510 of a preferred embodiment of the present invention.

### Biological Filtering

The biological filtering 500 can incorporate various biological media 510 as the filtration devices. In FIGS. 3A and 3B, the biological media are depicted as Bio-Balls 510. The use of biological media 510, such as Bio-Balls, is known and well understood in the art. The purpose of the biological media 510 is to provide adequate surface area for the growth of beneficial bacteria that will help breakdown toxic waste into less harmful chemicals by taking advantage of nature's nitrogen cycle to detoxify organic waste products.

The Bio-Balls, for example, can remove the excess ammonia that builds up as a result of the life in the pond. Biological filtration is the process that helps to remove this excess ammonia because the surface area of the Bio-balls provides a convenient location for the development of helpful bacteria that feed on the ammonia and break it down into nitrites. Although the nitrites can also be harmful to the pond environment, a subsequent colony of bacteria will develop on the Bio-Balls, which can further break down the nitrites to form nitrates. The nitrates are known to be less harmful to the fish in the pond, and the nitrates can be beneficially utilized by the plants in the pond.

In an exemplary embodiment, the pump 300 is located outside the base assembly 200, thus there is additional real estate available in the interior of the bottom portion 210 of the base assembly 200 to receive at least 20 Bio-Balls. Also, because there is easy access for cleaning, maintenance, and/or replacement of component parts (pump 300, mechanical filters 410, fountain sprayer mechanism 600), it is not necessary to open the base assembly 200 and risk disturbing the biological media 510. Thus, the biological filtering 500 provided by the bio-filter filtration system 100 is superior to conventional systems.

### Fountain Sprayer Mechanism

With reference again to FIG. 2, the filtration system 100 described herein also can include a fountain sprayer mechanism 600. The fountain sprayer mechanism 600 can optionally be used as a direct return mechanism to return the filtered water into the fish pond or other body of water while providing a decorative effect. The fountain sprayer mechanism 600 can include a flow control valve 610, one or more fountain extension tubes 640, and a fountain body 650.

The flow control valve 610 can be a two-way control valve that provides the capability to direct the return flow of filtered water though the fountain extension tubes 640 (for creating a fountain effect) and/or through the side aperture 700 (for direct return of the water into the pond). The flow control valve 610 contains one inlet aperture 670 and two outlet apertures: a top aperture 630 and a side aperture 700. The inlet aperture 670 of the flow control valve 610 connects to a fountain connection 310 of the pump 300. As with all the other connections, the connection can be made, for example, by a press fit without the need for any tools or specialized equipment.

If a fountain effect is not desired, the flow control knob 620 of the two-way control valve 610 can be “closed” to prohibit the flow of water into the fountain extension tubes 640. Likewise, if the flow control knob 620 is “opened,” the fountain sprayer mechanism 600 is in operation.

The fountain extension tubes 640 can be nesting tubes that can be telescopically connected together end to end and then to the top aperture 630 of the two-way control valve 610 in a like manner. The configuration depicted in FIG. 2 shows two fountain extension tubes 640; however, this should not be considered limiting to the scope of the present invention.

The fountain body 650 can be attached to a terminal end 645 of the fountain extension tubes 640 for producing a fountain effect for decorative purposes. The exit stream from the fountain body 650 can be varied to the user's choice by selecting any one of a number of fountain nozzle adaptors 660 that can be attached to the exit nozzle of the fountain body 650.

### Pump

The filtration system 100 can use a pump 300 that can be attached to the bottom portion 210 of the base 200 via the base connection 320 that is inserted into the base aperture 240. In one embodiment, a submersible centrifugal pump such as the Flow Rite submersible pump, manufactured by General Foam Plastics Corporation, of Norfolk, Va., can be used. The attachment of such a pump 300 to the filtration system 100 is depicted in FIG. 2.

The aforementioned pump 300 is capable of being completely submersible, so it can be located in the pond (or other body of water) along with the filtration system 100 during operation. Pump 300 can be magnetically driven and contains no seals to leak or wear out. Also, the pump 300 contains no oil, in contrast to other submersible utility pumps, thereby eliminating the possibility of oil leaks that can foul the water in the pond. All electrical parts and connections can be encapsulated with epoxy, which provides a safe and convenient pump that is economical to operate and requires little or no maintenance. Because the pump is designed to operate while submerged, there is no need for priming or bleeding of the pump, and the flow of water can initiate upon activation of the pump.

The pump 300 is designed to operate while completely submerged. Nevertheless, improved performance of the filtration system 100 can be achieved by resting the pump 300 on a brick or patio stone (or other raised surface) in the water such that the assembly is raised above the floor of the pond and thereby avoids contact with any debris that is likely to settle on the bottom of the pond. Also, by locating the pump 300 outside the base 200, there is more room available inside the bottom portion 210 of the base 200 for the biological media 510 to function without disturbance.

The pump 300 is powered and operated in a conventional manner.

### Location of the Filtration System

The assembled filtration system 100, which includes the base 200, the mechanical filters 410, the biological filters 510, and the fountain sprayer mechanism 600, can be located along with the pump 300 within the pond itself—as opposed to conventional filtration systems that require the filter (or a portion thereof) and/or the pump to be located outside the pond. This feature avoids the additional burden of having to decorate or camouflage the filter to preserve the natural appearance of the pond environment.

Because the pump 300 connects directly to the filtration system 100 (via the pump connection 240 and the pump coupling mechanism 310), the need for long tubing or hoses is eliminated, which reduces the volume required to accommodate the system in the pond.

### Coupling of Multiple Filtration Systems

In an exemplary embodiment, the filtration system 100 described herein further includes the capability to couple two or more filter systems in series to form a chain of filters as depicted in FIG. 5. Two base assemblies 100 and 101, connected in series are shown. It will be understood that more than two assemblies can be connected for operation by a single pump. Because the various component parts are interchangeable, the same component parts can be used in each of the connected systems 100 and 101, namely, the base assembly 200, the mechanical filters 410, biological filters 500, and fountain sprayer mechanism 600. The coupling of multiple base assemblies provides enhanced filtering by the addition of the mechanical filters 410 and biological media 510 provided by each additional base assembly connected in series.

The connection is accomplished by way of the base coupling mechanism 800, located on a rear face 250 of each base assembly 200 to be connected in series. Each base coupling mechanism 800 comprises an aperture 810 that is sized to receive a base coupler (not shown) that can connect two systems, as depicted in FIG. 5. When there is only one base assembly unit 200, or when it is desired to close off the aperture 810 of the base assembly 200, a plug (not shown) can be inserted into the aperture 810 to block the flow of water. Similarly, the base aperture 240 of the outermost base assembly 200 (the second system 101 as depicted in FIG. 4B), can be closed off by way of a plug (not shown) to block the flow of water.

Embodiments of the present invention include a filtration system for fish ponds and the like is configured to provide both mechanical filtering and biological filtering in a self-contained apparatus. The filtration system includes multiple cylindrically-shaped filters adapted to provide improved mechanical filtering over conventional systems. The filtration system further includes a base that incorporates a thin-walled structure with a cavity to accommodate biological media, such as Bio-Balls, to also provide biological filtering. The base includes a detachable lid portion that allows convenient access to the biological media for ease of cleaning, maintenance, and replacement. The mechanical filters attach to the lid portion of the base via strainer components that are detachably coupled to the lid portion of the base. The filter components are interchangeable and can be easily installed onto, and removed from, the strainer. The component parts are sized for ease of attachment, by way of a press fit assembly, without the need for hoses, seals, or other specialized equipment. The filtration system can further include a fountain sprayer mechanism, controlled by a two-way control valve, which can optionally be used to provide a decorative effect. The filtration system is further attached to a submersible, centrifugal pump such that the assembly can operate while submerged in the fish pond without the need to decorate or camouflage the system to preserve the natural appearance of the pond. Because the pump is designed to operate while submerged, there is no need for priming or bleeding of the pump, and the flow of water can begin immediately upon turning on the pump. The filtration system and pump are easily separated when the pump requires maintenance or replacement without disturbing the natural ecosystem. By connecting two or more base assemblies in series, via a base coupling mechanism, the user can achieve increased filtering without the necessity to purchase and install additional pumps.

Whereas the above embodiments have been described in detail with accompanying figures, it will be understood that various changes from these embodiments can be made without departing from the scope or sprit of the invention

What is claimed is:

1. A filtration system for filtering a liquid, the system comprising:
a base assembly comprising:
at least one mechanical filter; and
at least one form of biological media; and
a base connection for attachment of the base assembly to a pump.

2. The system of claim 1, wherein the base assembly further comprises a bottom portion and a detachable lid portion, the at least one mechanical filter extending above the detachable lid portion, the at least one form of biological media contained within a cavity formed between the bottom portion and the detachable lid portion.

3. The system of claim 2, wherein the bottom portion of the base assembly comprises a base connection to operably couple the base assembly to the pump.

4. The system of claim 2, wherein the mechanical filters are releasably attached to the detachable lid portion.

5. The system of claim 2, wherein at least one of the at least one mechanical filter is detachably coupled to the detachable lid portion such that the at least one of the at least one mechanical filter can be accessed without disturbing the biological media.

6. The system of claim 1, the filtration system further comprising the pump, the pump comprising a submersible centrifugal pump.

7. The system of claim 1, wherein at least one form of biological media comprises Bio-balls.

8. The system of claim 1, wherein the at least one mechanical filter comprises a strainer component and a filter component.

9. The system of claim 8, wherein the strainer component is releasably attached to an upper surface of the lid portion.

10. The system of claim 8, wherein the strainer component is sized and shaped to receive the filter component therein.

11. The system of claim 8, wherein the filter component comprises a foam material with a cylindrical aperture through its core sized to accept the strainer component therein.

12. The system of claim 1, the liquid comprising water, the system further comprising a two-way control valve for controlling water flow.

13. The system of claim 12, further comprising a fountain sprayer mechanism, the fountain sprayer mechanism controlled by the two-way control valve.

14. The system of claim 13, wherein the two-way control valve provides a decorative effect and returns filtered water back into the pond.

15. The system of claim 13, wherein the two-way valve has an inlet aperture attached directly to a fountain connection of the pump and a first outlet aperture connected to the fountain sprayer mechanism.

16. The system of claim 13, wherein the two-way valve further comprises a control knob for controlling the supply of water to the fountain.

17. The system of claim 15, wherein the two-way valve has a second outlet aperture used as a return mechanism for directing at least a portion of water back into a pond.

18. A system for maintaining the quality of a volume of liquid, the system comprising:
a pump at least partially submerged in the volume of liquid;
up to five base assemblies connected in series, wherein the five base assemblies comprise:
a bottom portion;
a detachable lid portion;
at least one mechanical filter that extends above the detachable lid portion; and
at least one form of biological media contained within a cavity formed between the bottom portion and the detachable lid portion; and
wherein at least one of the five base assemblies comprises a base connection for attachment of the at least one base assembly to the pump; and
a fountain sprayer mechanism.

19. The system of claim 18, wherein at least one form of biological media comprises Bio-balls.

20. The system of claim 18, wherein the at least one mechanical filter comprises a strainer component and a filter component.
